(19) United States
(12) Patent Application Publication
(10) Pub. No.: US 2026/0145633 A1
(43) Pub. Date: May 28, 2026

(54) AIR INTAKE STRUCTURE AND LIMB RISER FOR WORK VEHICLE

(71) Applicant: Komatsu America Corp., Chicago, IL (US)

(72) Inventors: Colin HARTIGAN, Shawano, WI (US); Gene HUELMAN, Green Bay, WI (US)

(21) Appl. No.: 19/402,459

(22) Filed: Nov. 26, 2025

Related U.S. Application Data
(60) Provisional application No. 63/725,692, filed on Nov. 27, 2024.

(51) Int. Cl. B60R 21/11; B60K 13/02; B62D 25/12; B62D 33/06; B62D 33/067

(52) U.S. Cl. CPC B60R 21/11; B60K 13/02; B62D 25/12; B62D 33/0617; B62D 33/067

(57) ABSTRACT

A limb riser structure for a work vehicle includes an attachment structure, a support structure, and a limb riser. The attachment structure is attached to an end portion of a vehicle body of the work vehicle. The support structure is disposed in a position between a cab of the work vehicle and the end portion of the vehicle body. The limb riser has a first attaching portion attached to the attachment structure and a second attaching portion attached to the support structure. The limb riser extends toward the cab from the attachment structure. An air intake structure includes a first pillar and a second pillar attached to the work vehicle in an upright orientation. The first pillar and the second pillar are spaced apart in a widthwise direction and form a duct. The first pillar and the second pillar may be part of the support structure.

### CROSS REFERENCE TO RELATED APPLICATIONS

This application claims the benefit under 35 U.S.C. § 119(e) of U.S. Provisional Application No. 63/725,692, filed Nov. 27, 2024. The entire disclosure of U.S. Provisional Application No. 63/725,692 is hereby incorporated herein by reference.

### BACKGROUND

### Field of the Invention

The present disclosure generally relates to an air intake structure and a limb riser for a work vehicle. More specifically, the present invention relates to a limb riser including a support member that forms a portion of an air intake structure connected to the air induction system of an engine provided in the work vehicle.

Some work vehicles are equipped with limb risers (also known as “sweeps), a roll bar, or other guard structure to protect the hood, the engine compartment, and the cab from materials being moved, handled, or otherwise encountered by the work vehicle. Work vehicles equipped with limb risers may be used in construction, farming, forestry, etc. Examples of work vehicles that may be provided with limb risers include dozers/forestry dozers, grapple skidders, loaders, and feller bunchers including drive-to-tree type feller bunchers. Skidders can be used to transport harvested trees over natural grounds such as a forest.

Limb risers typically include a pair of rod, pipe, or beam-like members that extend upward from one end of the vehicle and connect to the cab. The limb riser protects the top of the hood and windows of the cab from logs, limbs, and other debris that may ride up onto the body of the work vehicle when the work vehicle is pushing materials at a worksite or through a forest. In a forest, the limb riser sweeps tree limbs up over the operator cab so that the limbs do not damage the work vehicle or the windows of the operator cab. The limb riser also serves to protect exhaust pipes and air intake pipes that may be arranged on top of the hood. Generally, the longitudinal members of the limb riser are structurally supported by the end of the vehicle body (e.g., the hood covering the engine compartment) and by the cab. The longitudinal members of the limb riser are spaced apart in a widthwise direction of the work vehicle and such elements as an exhaust pipe or an air pre-cleaner may be disposed above the hood in the area between the pair of limb risers.

Some examples of work vehicles provided with limb risers are disclosed in U.S. Pat. Nos. 11,518,295, 9,096,121, Canadian Patent No. 2,934,380, U.S. Pat. Nos. 8,770,329, and 7,857,017.

### SUMMARY

Dozers, skidders, feller bunchers, and other work vehicles throughout the industry generally have an intake stack including an air pre-cleaner mounted above the hood on one end of the work vehicle. It has been discovered that this arrangement leaves the air pre-cleaner subject to damage and blocks the view of the operator, which is generally restricted already due to the hood and engine compartment. Additionally, dozers, skidders, feller bunchers, and other work vehicles may be configured such that the cab tilts away from the frame to allow for maintenance. Since it is standard for the limb risers to be attached to the cab, operators may be required to climb onto a tire or on top of the machine to remove the limb risers before they the cab can be tilted. This task can be dangerous for the operator because logging equipment is often used in muddy and slippery conditions.

An object of the present application is to provide a limb riser structure that does not inhibit tilting of the cab or require an operator to detach the limb risers before tilting the cab. Another object of the present application is to provide an air intake structure that does not place the air pre-cleaner on the hood where it obstructs the view of the operator and may be subject to damage.

In view of the state of the known technology and in accordance with a first aspect of the present disclosure, a limb riser structure for a work vehicle is provided. The limb riser structure includes an attachment structure, a support structure, and a limb riser. The attachment structure is configured to be attached to an end portion of a vehicle body of the work vehicle. The support structure is configured to be disposed in a position between a cab of the work vehicle and the end portion of the vehicle body. The limb riser has a first attaching portion attached to the attachment structure and a second attaching portion connected to the support structure. The limb riser extends toward the cab from the attachment structure.

In a limb riser structure according to a second aspect of the present disclosure, the limb riser structure may be configured to be supported with respect to the work vehicle by the attachment structure and the support structure without being connected to the cab of the work vehicle.

In a limb riser structure according to a third aspect of the present disclosure, the support structure may be configured to be disposed between the cab and a furthest point of the work vehicle.

In a limb riser structure according to a fourth aspect of the present invention, the limb riser may extend beyond the support structure toward the cab.

In a limb riser structure according to a fifth aspect of the present disclosure, a rearward end of the limb riser may be disposed forward of the cab when the limb riser structure is installed on the work vehicle.

In a limb riser structure according to a sixth aspect of the present disclosure, a space may exist between the rearward end of the limb riser and the cab when the limb riser structure is installed on the work vehicle.

In a limb riser structure according to a seventh aspect of the present disclosure, the support structure may include a duct and an air intake port communicating between an inside and an outside of the duct.

In a limb riser structure according to an eighth aspect of the present disclosure, the support structure may include a tubular member that both forms the duct and supports the limb riser.

In a limb riser structure according to a ninth aspect of the present disclosure, the tubular member may be a pillar configured to be attached to a frame of the work vehicle in an upright orientation.

In a limb riser structure according to a tenth aspect of the present disclosure, the support structure may include a pair of pillars configured to be attached to a frame of the work vehicle in an upright orientation. The pillars may be spaced apart from each other in a widthwise direction of the work vehicle. Each of the pillars may form a duct and have an air intake port communicating between an inside and an outside of the duct.

In a limb riser structure according to an eleventh aspect of the present disclosure, the air intake port of each of the pillars may face inward in the widthwise direction of the work vehicle.

In view of the state of the known technology and in accordance with a twelfth aspect of the present disclosure, an air intake structure is provided. The air intake structure may include a first pillar, a second pillar, and an air pre-cleaner. The first pillar and the second pillar are configured to be attached to a frame of the work vehicle in an upright orientation. The first pillar and the second pillar are spaced apart from each other in a widthwise direction of the work vehicle. Each of the first pillar and the second pillar forms a duct and has an air intake port communicating between an inside and an outside of the duct. The air pre-cleaner is connected to the duct of the first pillar and the duct of the second pillar.

In an air intake structure according to a thirteenth aspect of the present disclosure, the air intake ports of the first pillar and the second pillar may face inward in the widthwise direction of the work vehicle.

In an air intake structure according to a fourteenth aspect of the present disclosure, the air intake structure further may include a connecting member. The connecting member may span between the first pillar and the second pillar and have an internal space communicating with the duct of the first pillar and the duct of the second pillar. The air pre-cleaner may be connected to the duct of the first pillar and the duct of the second pillar via the connecting member.

In an air intake structure according to a fifteenth aspect of the present disclosure, the air intake structure may be configured such that the connecting member and the air pre-cleaner are disposed below a hood of the work vehicle when the air intake structure is installed on the work vehicle.

In an air intake structure according to a sixteenth aspect of the present disclosure, the air intake structure may further include an engine tube connected to an outlet side of the air pre-cleaner. The engine tube may be configured to be connected to an air induction port of an engine.

In an air intake structure according to a seventeenth aspect of the present disclosure, an air cleaner may be disposed between the air pre-cleaner and the engine tube.

In an air intake structure according to an eighteenth aspect of the present disclosure, the air intake structure may further include an air box disposed between the air pre-cleaner and the air cleaner such that air exiting the air pre-cleaner enters the air box before flowing into the air cleaner.

In view of the state of the known technology and in accordance with a nineteenth aspect of the present disclosure, a work vehicle is provided. The work vehicle includes a cab, an engine, a hood, an air pre-cleaner, and a limb riser structure. The hood covers the engine. The air pre-cleaner is disposed under the hood between the engine and the cab. The limb riser structure includes a limb riser and a duct. The duct is connected to the pre-cleaner. The duct communicates between an inlet side of the air pre-cleaner and ambient air.

In a work vehicle according to a twentieth aspect of the present disclosure, the cab is configured to be tiltable with respect to a frame of the work vehicle. The limb riser structure is configured to permit the cab to be tilted while limb riser structure remains in place.

It will be apparent to those having ordinary skill in the art from this disclosure that the above aspects are merely examples of illustrative embodiment(s) of this invention and do not limit the scope of this invention.

Also, other objects, features, aspects and advantages of the disclosed work vehicle will become apparent to those skilled in the work vehicle field from the following detailed description, which, taken in conjunction with the annexed drawings, discloses exemplary embodiments of the work vehicle.

### BRIEF DESCRIPTION OF THE DRAWINGS

The attached drawings will now be described. These drawings form a part of this original disclosure.

FIG. 1 is perspective view showing the right side of a work vehicle provided with a an air intake structure and limb riser in accordance with an embodiment;

FIG. 2 a perspective view of the right side work vehicle as seen from a different angle than in FIG. 1;

FIG. 3 is a side view of the work vehicle;

FIG. 4 is a top plan view of the work vehicle;

FIG. 5 is a front view of the work vehicle;

FIGS. 6A-6G show the air intake structure and support structure from a plurality of points of view, specifically, FIG. 6A is a perspective view of the right side of the air intake structure, FIG. 6B is a top plan view of the air intake structure, FIG. 6C is a perspective view of the left side of the air intake structure, FIG. 6D is a rear view of the air intake structure, FIG. 6E is a right side view of the air intake structure, FIG. 6F is a front view of the air intake structure, and FIG. 6G is a left side view of the air intake structure;

FIG. 7 is a left perspective view of the air intake system including the air intake structure;

FIG. 8A is a partial left perspective view showing the vehicle body and the engine compartment (without enclosures thereon) of a work vehicle provided with the air intake structure and limb riser in accordance with the embodiment, and FIG. 8B is a partial left side view showing the vehicle body and the engine compartment (without enclosures thereon) of a work vehicle provided with the air intake structure and limb riser in accordance with the embodiment;

FIG. 9 is a partial right perspective view showing the vehicle body and the engine compartment (without enclosures thereon) of a work vehicle provided with the air intake structure and limb riser in accordance with the embodiment;

FIG. 10A is a partial left perspective view showing the vehicle body and the engine compartment (without enclosures thereon) of a work vehicle provided with the air intake structure and limb riser in accordance with the embodiment, and FIG. 10B is a partial left side view showing the vehicle body and the engine compartment (without enclosures thereon) of a work vehicle provided with the air intake structure and limb riser in accordance with the embodiment;

FIG. 11 is a partial top plan view showing the vehicle body and the engine compartment (without enclosures thereon) of a work vehicle provided with the air intake structure and limb riser in accordance with the embodiment; and

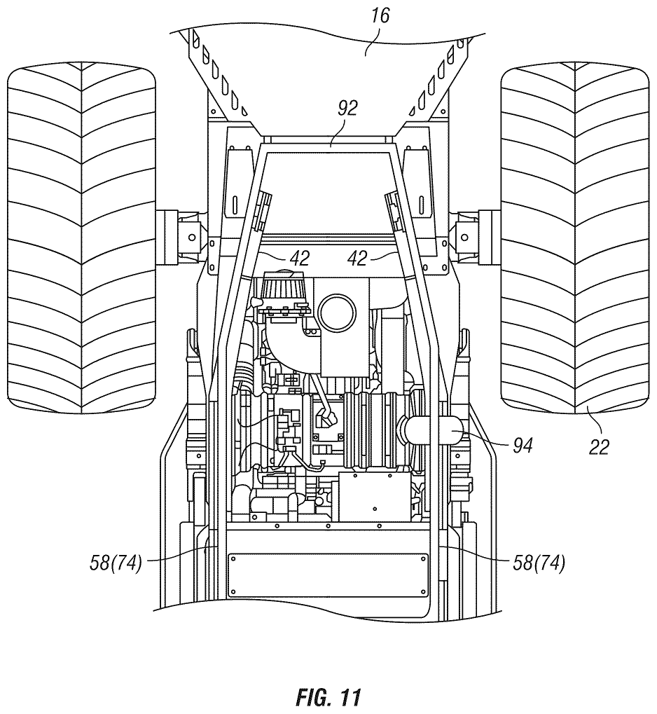

FIG. 12 is a partial left perspective view showing the engine compartment (without enclosures thereon) of a work vehicle provided with the air intake structure and limb riser in accordance with the embodiment.

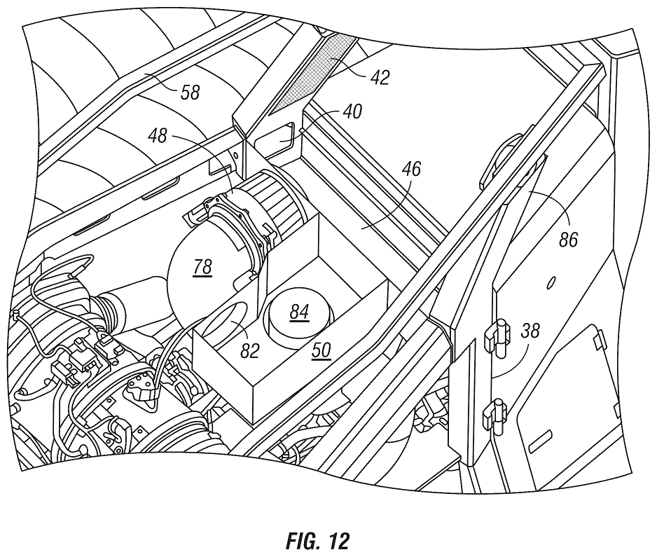

### DETAILED DESCRIPTION OF THE EMBODIMENT(S)

Selected embodiments will now be explained with reference to the drawings. It will be apparent to those skilled in the art from this disclosure that the following description of the embodiments is provided for illustration only and not for the purpose of limiting the invention as defined by the appended claims and their equivalents.

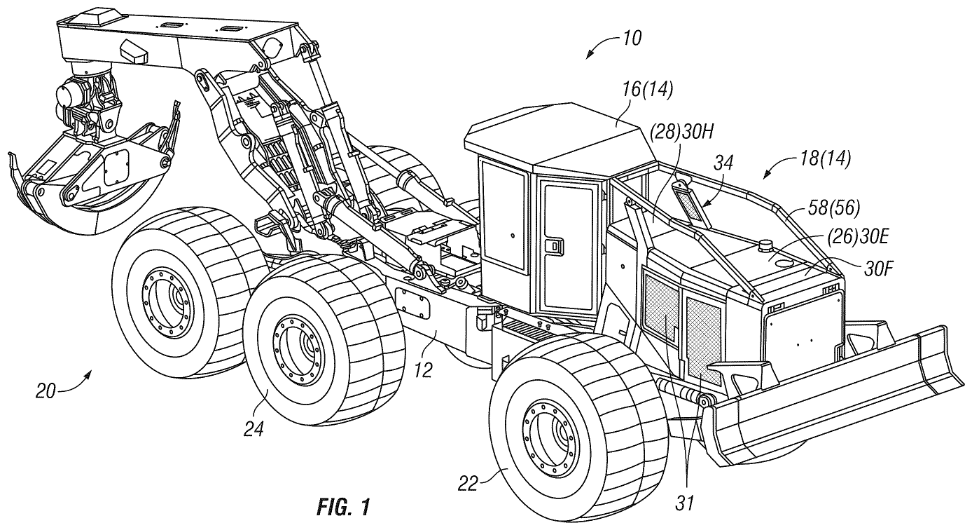

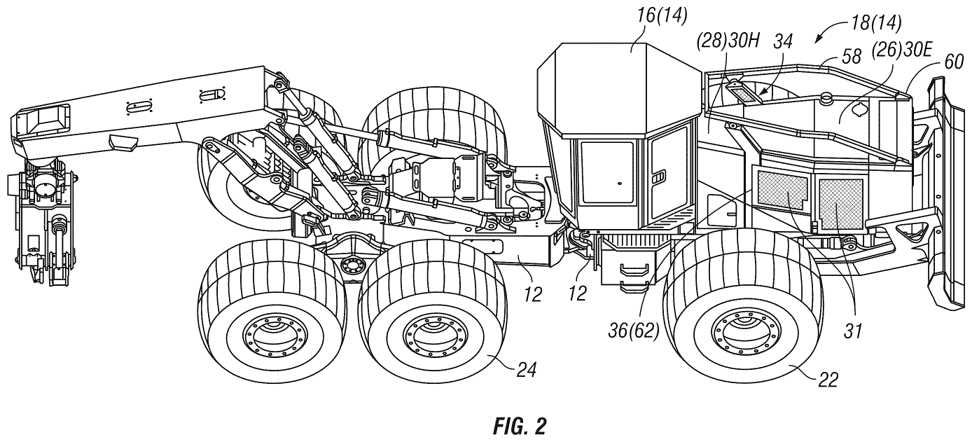

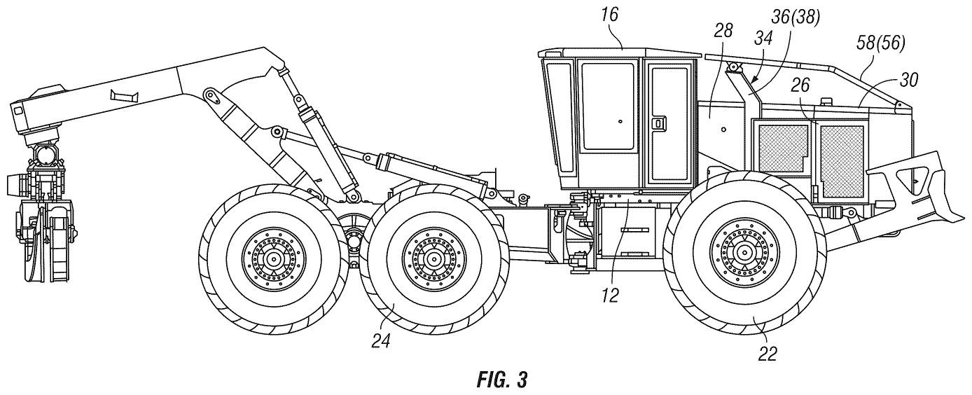

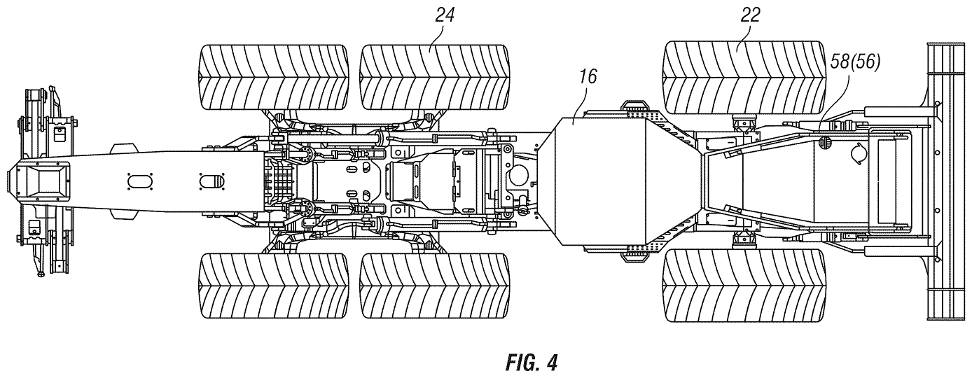

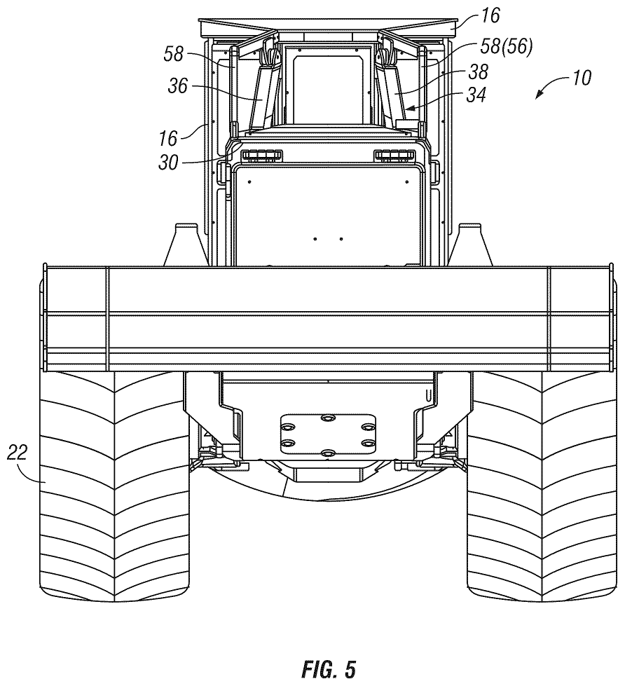

FIGS. 1-5 illustrate a work vehicle 10 in accordance with an exemplary embodiment of the present disclosure. The work vehicle 10 includes a frame 12 and a vehicle body 14. The vehicle body 14 includes an operator cab 16 and a front section 18. The operator cab 16 and the front section 18 are mounted to the frame 12. The work vehicle 10 also includes a ground propulsion apparatus 20. In the illustrated embodiment, the ground propulsion apparatus 20 includes two front wheels 22 and four rear wheels 24. It will be apparent to those of ordinary skill in the field of work vehicles that the ground propulsion apparatus 20 may have other configurations. For example, the ground propulsion apparatus may include only two rear wheels 24 or the ground propulsion apparatus may include tracks instead of wheels. Also, in the illustrated embodiment, the work vehicle is an articulated work vehicle in which the frame 12 includes a front vehicle frame and a rear vehicle frame pivotably connected together. However, those of ordinary skill in the work vehicle field will understand that the present disclosure is not limited to an articulated work vehicle.

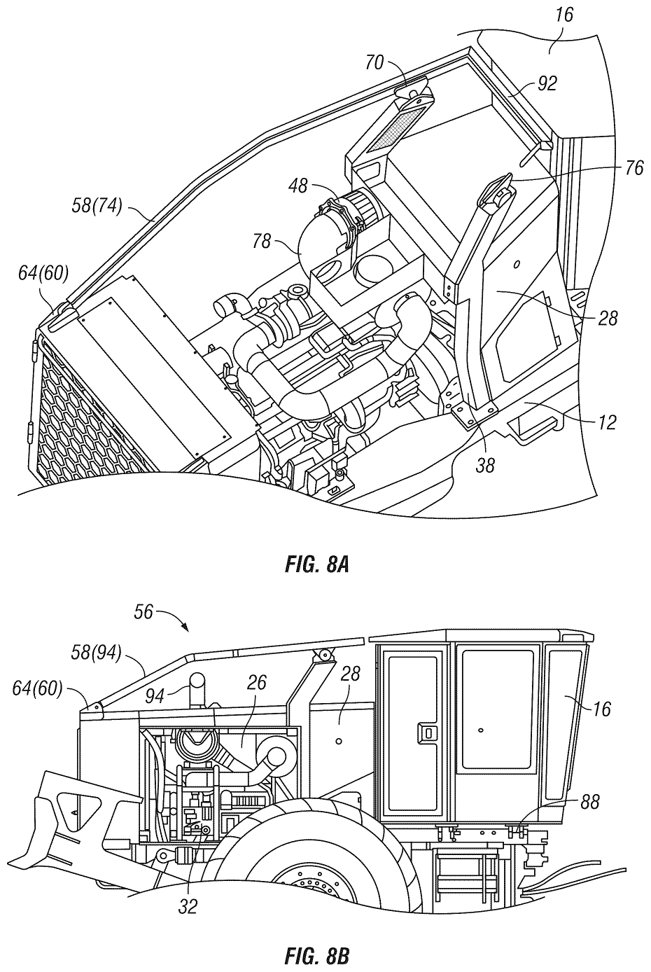

The operator cab 16 and the front section 18 are disposed on the frame 12. The front section 18 includes an engine compartment 26 and a hydraulic tank compartment 28. These compartments 26, 28 are covered by the enclosures, i.e., one or more hoods 30 and one or more side shield panels 31. At least upper parts of the engine compartment 26 and the hydraulic tank compartment 28 are enclosed by the hood 30 such that the hood 30 covers the engine 32 and a hydraulic tank (not shown). While the hood 30 is made by a thin metal plate and may be divided into portions, such as an engine hood 30E, a hydraulic tank hood 30H, and a front (radiator) hood 30F, these hoods 30E, 30H, 30F are collectively referred to as the hood 30. Further, the side part of the engine compartment 26 is covered by one or more side shield panels 31. The engine compartment 26 contains an engine 32 (see FIG. 8) that provides motive power for driving the ground propulsion apparatus 20. The hydraulic tank compartment 28 encloses the hydraulic tank and other hydraulic components for driving various actuators and other components of the work vehicle 10. In the illustrated embodiment, the engine compartment 26 is disposed forward of the hydraulic tank compartment 28 such that the hydraulic tank compartment 28 is between the operator cab 16 and the engine compartment 26.

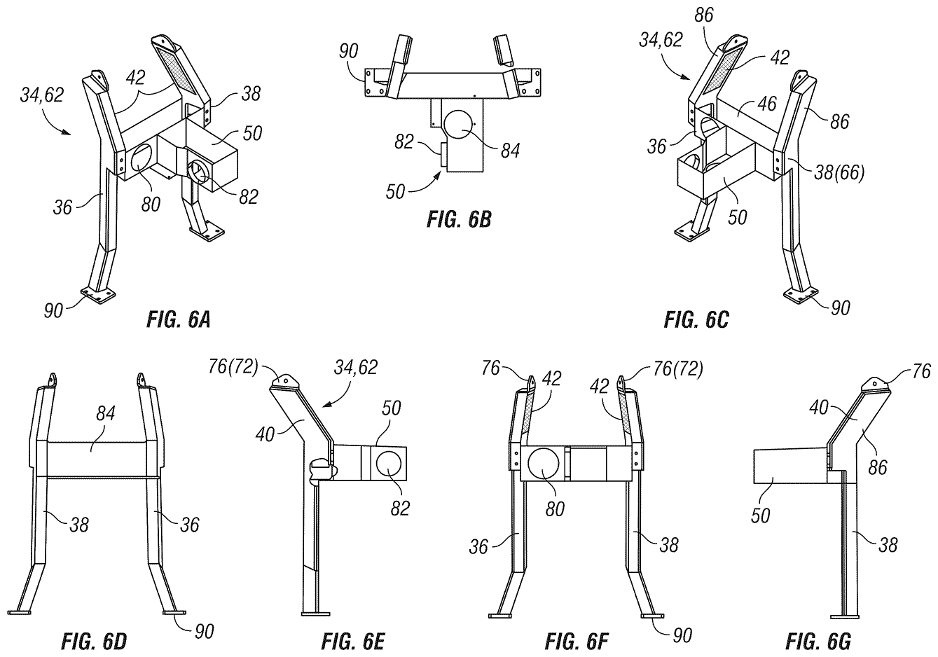

Now turning to FIGS. 6-10B, the work vehicle 10 includes an air intake system for conveying outside air to an air induction port of the engine 32. The air intake system includes an air intake structure 34 that serves as a structural support for other components of the air intake system and also forms an initial inlet and passage for guiding the outside air into the air intake system. The air intake structure 34 includes a tubular member 66 that forms a duct 40. In the illustrated embodiment, the tubular member 66 includes a first pillar 36 and a second pillar 38 configured to be attached to the frame 12 of the work vehicle 10 in an upright orientation. The first pillar 36 and the second pillar 38 are spaced apart from each other in a widthwise direction of the work vehicle 10. Each of the first pillar 36 and the second pillar 38 includes a duct 40, and each of the first pillar 36 and the second pillar 38 has an air intake port 42 communicating between an inside and an outside of the duct 40. In some embodiments, the air intake ports 42 of the first pillar 36 and the second pillar 38 face inward in the widthwise direction of the work vehicle 10. In other words, the air intake ports 42 may face towards each other across the hood 30. A connecting member 44 is provided spanning between the first pillar 36 and the second pillar 38. The connecting member 44 has an internal space 46 communicating with the duct 40 formed by each of the first pillar 36 and the duct of the second pillar 38.

Each of the first pillar 36, the second pillar 38, and the connecting member 44 of the air intake structure 34 is made of a rigid material that has formed into a tubular shape that is hollow inside. The material may be a metal material, such as aluminum, iron, or steel. In the illustrated embodiment, the material is a steel sheet that has been formed into the first pillar 36, the second pillar 38, and the connecting member 44 and attached together. The first pillar 36, the second pillar 38, and the connecting member 44 may be attached together by any suitable attaching method. For example, bolts, rivets, or some other type of fastener may be used. In the illustrated embodiment, the illustrated embodiment the first pillar 36, the second pillar 38, and the connecting member 44 are welded together such that the entire air intake structure 34 forms a structural weldment. Alternatively, the entire air intake structure can be formed as a one-piece member. There are no particular limitations on the method of manufacturing the air intake structure 34.

Each of the first pillar 36 and the second pillar 38 is a substantially straight member configured to be arranged upright on the frame 12. The straight member may be bent or curved at certain portions along its length to accommodate the shape of the hood 30, the engine compartment 26, and the hydraulic tank compartment 28. A lower end of each of the first pillar 36 and the second pillar 38 is securely fastened to the frame 12. The lower ends of the first pillar 36 and the second pillar 38 are fastened to the frame 12 with fasteners (e.g., bolts or screws), by welding, or by some other suitable fastening method. In the illustrated embodiment, a flat plate 90 is welded to the bottom end of each of the first pillar 36 and the second pillar 38. The flat plate 90 includes bolt holes through which bolts are inserted and installed into the frame 12. However, it will be apparent to those of skill in the work vehicle field that the present disclosure is not limited to the specific method of attaching the first pillar 36 and the second pillar 38 to the frame 12 that is shown in the appended drawings.

In the illustrated embodiment, an upper portion 86 of each of the first pillar 36 and the second pillar 38 extends upward from the connecting member 44. The upper portion 86 includes the duct 40 and the air intake port 42 of the first pillar 36 or the second pillar 38. The air intake ports 42 of the first pillar 36 and the second pillar 38 are disposed above the hood 30. In some embodiments, the upper portions 86 of the first pillar 36 and the second pillar 38 may be bent to tilt inward toward each other. For example, each the upper portions 86 may be tilted inward at an angle of 5 to 25 degrees relative to a vertical direction. A screen or a grate may be provided over each of the air intake ports 42. The inward tilt of the upper portions the first pillar 36 and the second pillar 38 may help prevent dust and debris from entering the air intake ports 42.

In some embodiments, the first pillar 36 and the second pillar 38 may be further supported by being attached to the hood 30, i.e., the engine hood 30E or the hydraulic tank hood 30H, or to members of a framework that forms the engine compartment 26 and the hydraulic tank compartment 28. In the illustrated embodiment, lower portions of the first pillar 36 and the second pillar 38 are supported by a partition wall between the engine compartment 26 and the hydraulic tank compartment 28, and the outwardly facing side surfaces of upper portions of the first pillar 36 and the second pillar 38 are exposed to the outside of the work vehicle 10. However, the present disclosure is not limited to such an arrangement. Portions of the first pillar 36 and the second pillar 38 may be disposed inside the engine compartment 26 or the hydraulic tank compartment 28. Alternatively, the first pillar 36 and the second pillar 38 may be disposed partially or completely outside the engine compartment 26 and the hydraulic tank compartment 28.

The air intake system also includes an air pre-cleaner 48, an air box 50, and an air cleaner 52. The air pre-cleaner 48 is arranged on an upstream side of the air box 50 and the air box 50 is arranged on an upstream side of the air cleaner 52. Thus, air passes sequentially through the air pre-cleaner 48, the air box 50, and the air cleaner 52 on its way to the engine 32.

The air pre-cleaner 48 is disposed under the hood 30 between the engine 32 and the cab 16. The air pre-cleaner 48 is connected to the duct 40 of the first pillar 36 and the duct 40 of the second pillar 38. In some embodiments, the air pre-cleaner 48 may be connected to each of the duct 40 of the first pillar 36 and the duct 40 of the second pillar 38 via the connecting member 44. In the illustrated embodiment, the air pre-cleaner 48 is attached to the connecting member 44 and both the connecting member 44 and the air pre-cleaner 48 are disposed below the hood 30 of the work vehicle 10 when the air intake structure 34 is installed on the work vehicle 10.

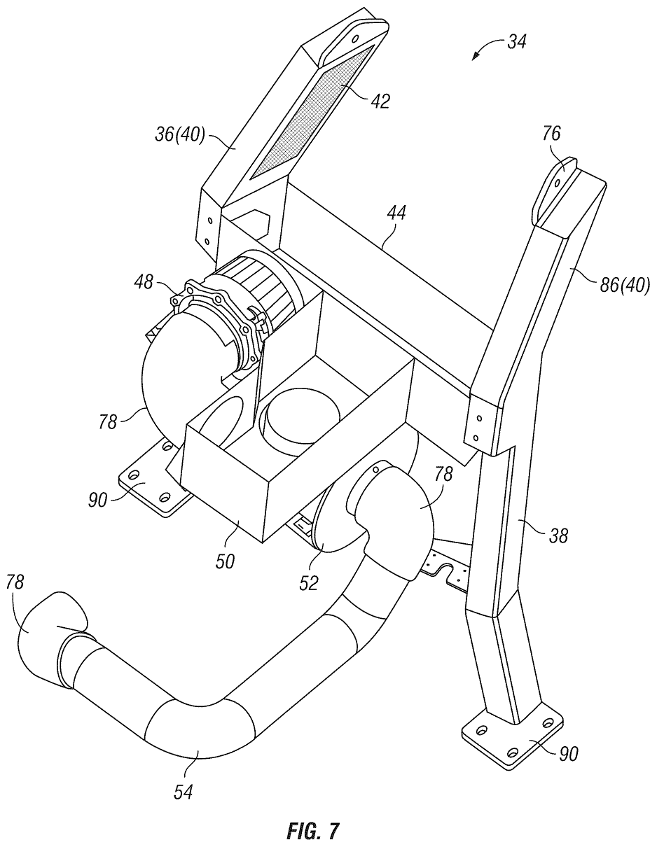

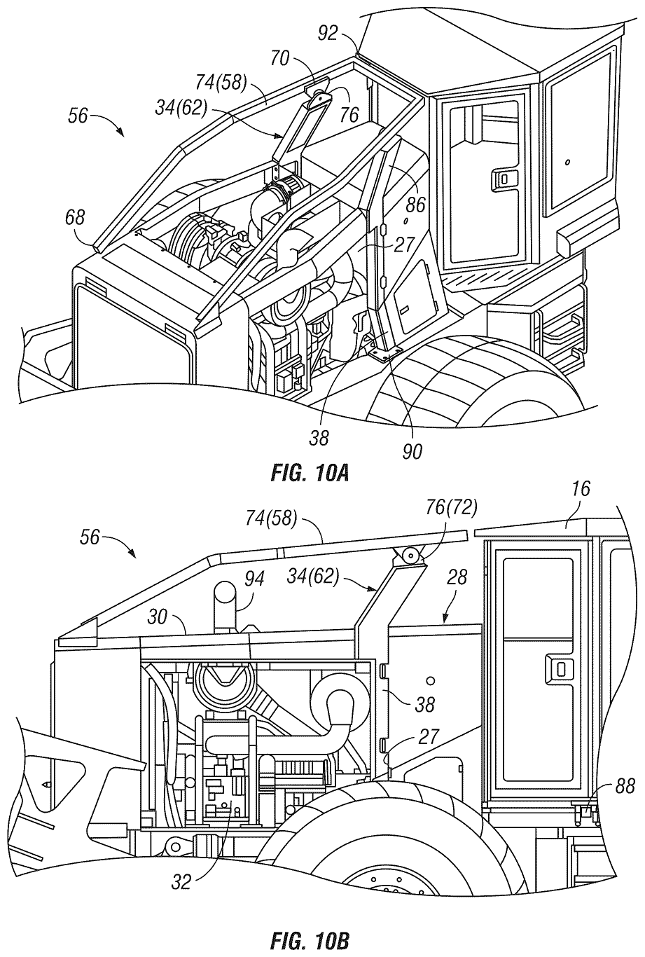

The air intake structure 34 also includes an engine tube 54. The engine tube 54 is connected to an outlet side of the air pre-cleaner 48 via the air cleaner 52 and the air box 50. Thus, the air cleaner 52 is disposed between the air pre-cleaner 48 and the engine tube 54, and the air box 50 disposed between the air pre-cleaner 48 and the air cleaner 48 such that air exiting the air pre-cleaner 48 enters the air box 50 before flowing into the air cleaner 52. The engine tube 54 is connected to the outlet side of the air cleaner 52 and configured to be connected to the air induction port of the engine 32. Rubber elbows 78 may be used for connections between these components. For example, as best seen in FIG. 7, in the illustrated embodiment a rubber elbow 78 is used to connect the air cleaner 48 to the air box 50. Another rubber elbow 78 is used to connect the air cleaner 52 to the engine tube 54. Another rubber elbow 78 is used to connect the engine tube 54 to the engine 32. In the illustrated embodiment, as best seen in FIGS. 8A, 8B, 10A, and 10B, the exhaust side of the engine 32 is connected to an exhaust pipe 94 disposed on top of the hood 30 above the engine 32.

As illustrated in FIGS. 6A-C and 8A, the air box 50 is a rectangular box-like member that is fixed to a front side of the connecting member 44. The air box 50 may be made of the same material as the first pillar 36, the second pillar 38, and the connecting member 44, or the air box may be made of another suitable material. In the illustrated embodiment, the air box is made of metal and is securely fastened to the connecting member 44 by welding. Fasteners or another attaching method may also be used to fix the air box 50 to the connecting member 44. The front side of the connecting member 44 is provided with a front opening 80 adjacent to the air box 50 for mounting the air pre-cleaner 48 in communication with the ducts 40. The air box 50 is provided with a side opening 82 on one side that corresponds to the side where the air pre-cleaner 48 is mounted to the connecting member 44. An inlet side of the air pre-cleaner 48 is connected to the front opening 80 of the connecting member 44. An outlet side of the air pre-cleaner 48 is connected to the side opening 82 of the air box 50 with one of the rubber elbows 78. The air box 50 also includes a bottom opening 84 configured for mounting the air cleaner 52 to the air box 50. The air box 50 is a closed box except for the side opening 82 and the bottom opening 84.

The work machine 10 includes a limb riser structure 56 including a limb riser 58 and the duct 40, which is connected to the air pre-cleaner 48. The duct 40 communicates between an inlet side of the air pre-cleaner 48 and ambient air outside the work vehicle 10. The limb riser structure 56 includes a front attachment structure 60 and a support structure 62 in addition to the limb riser 58. Preferably, the duct 40 is formed by the support structure 62. However, in some embodiments, the duct 40 may be a pipe or other duct work that is attached to or incorporated into the support structure 62. In the illustrated embodiment, the support structure 62 basically corresponds to the air intake structure 34 described above. In other words, the support structure 62 is configured to function as the air intake structure 34 and includes the first pillar 36 and the second pillar 38 of the air intake structure 34 described above. In some embodiments, the work machine 10 may be provided with a rear attachment structure and the limb riser may extend from a rear end of the work vehicle toward the cab. The present application is not limited to a limb riser provided on a front portion of the work machine.

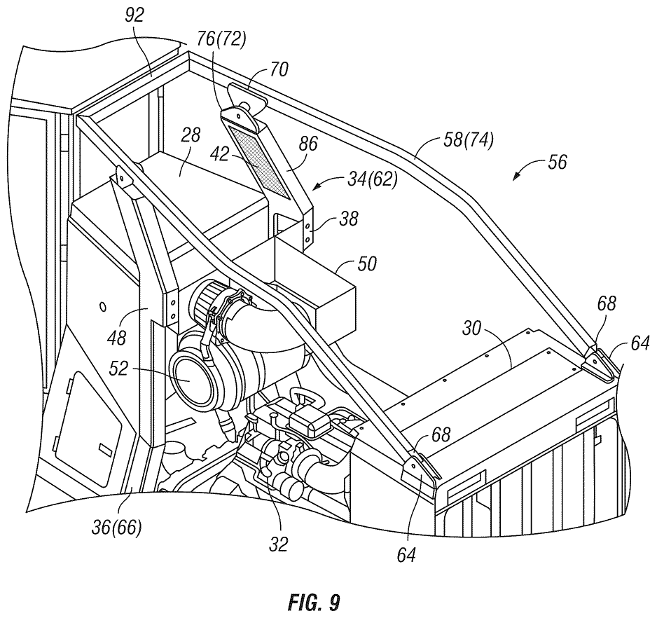

As best seen in FIG. 9, front attachment structure 60 is configured to be attached to a frontward portion of a vehicle body 14 of the work vehicle 10. In some embodiments, the front attachment structure 60 may include a front bracket 64 that is fixed to a frontward portion of the hood 30. The front bracket 64 may be fixed to the hood 30 by welding, by using fasteners, or by any other suitable attachment method. The front bracket 64 is preferably configured to enable the limb riser 58 to be attached and detached. For example, the front bracket 64 may be provided with bolt holes or with threaded bolts welded thereto to enable the limb riser 58 to be attached securely to the front bracket 64 in a detachable manner. In the illustrated embodiment, the front bracket 64 includes two bracket pieces spaced apart in a widthwise direction of the work vehicle 10 and attached to the vehicle body 14 at positions near the upper corners of the hood 30. However, those of ordinary skill in the work vehicle field will understand that the present disclosure is not limited to the specific positioning of the front bracket 64 shown in the drawings. The positioning of the front attachment structure 60 can be modified as necessary to accommodate the structure of the particular work vehicle and the structure of the limb riser 58.

The support structure 62 is configured to be disposed in a position between the operator cab 16 of the work vehicle 10 and the frontward portion of the vehicle body 14. In some embodiments, the support structure 62 is configured to be disposed between the operator cab 16 and the engine compartment 26 of the work vehicle 10. In the illustrated embodiment, the support structure 62 is disposed between the hydraulic tank compartment 28 and the engine compartment 26. The support structure 62 includes a tubular member 66 that forms the duct 40. The tubular member 66 also supports the limb riser 58. Preferably, the support structure includes a pair of pillars configured to be attached to the frame 12 in an upright orientation. In the illustrated embodiment, the tubular member 66 is formed by the first pillar 36 and the second pillar 38, which are configured to be attached to the frame 12 of the work vehicle 10 in an upright orientation. The first pillar 36 and the second pillar 38 are spaced apart from each other in a widthwise direction of the work vehicle 10. The first pillar 36 and the second pillar 38 form the duct 40 and the air intake port 42 communicating between the inside and the outside of the duct 40.

As best seen in FIGS. 8A and 8B, the limb riser 58 has a first attaching portion 68 attached to the front attachment structure 60 and a second attaching portion 70 attached to the support structure 62. The limb riser 58 extends in a rearward direction of the work vehicle 10 from the front attachment structure 60. In some embodiments, the limb riser 58 may extend beyond the support structure 62 toward the operator cab 16. In the illustrated embodiment, the first attaching portion 68 is provided on a frontward end of the limb riser 58 and the second attaching portion 70 is provided at an intermediate position along the lengthwise direction of the limb riser 58. The first attaching portion is attached to the two bracket pieces of the front bracket 64, and the second attaching portion 70 is attached to a rear attachment structure 72 provided on the support structure 62. In the illustrated embodiment, the rear attachment structure 72 is provided on an upper end of the support structure 62. However, a person skilled in the work vehicle field will understand that the rear attachment structure 72 can be positioned below the upper end of the support structure 62. That is, the position of the rear attachment structure 72 can be adjusted as necessary to accommodate the structure of the work vehicle 10 and the structure of the support structure 62.

In some embodiments, the upper portions 86 of the first pillar 36 and the second pillar 38 may be parallelogram-shaped such that the upper portions 86 are tilted slightly rearward. This configuration allows the rear attachment structure 72 of the support structure 62 to be positioned farther rearward and closer to the rearward end of the limb riser 58. This configuration also distances the air intake ports 42 from the exhaust pipe 94. In some embodiments, the upper portions 86 may be tilted rearward at an angle of 10 to 45 degrees with respect to the vertical direction. In the illustrated embodiment, the upper portions 86 of the first pillar 36 and the second pillar 38 extend upward from the connecting member 44 and include the duct 40 and the air intake port 42. The upper portions 86 tilt rearward from a position near the top of the connecting member 44. However, the present disclosure is not limited to such a configuration. The upper portions 86 may be oriented straight upward or tilted in a different direction as necessary in accordance with the structure of the particular work vehicle.

In some embodiments, the limb riser 58 includes a pair of longitudinal members 74 arranged to extend in a longitudinal (front-to-rear) direction of the work vehicle 10. In the illustrated embodiment, the front attaching portion 68 is a pair of front attaching portions 68 provided on the front ends of the pair of longitudinal members 74. Each of the front attaching portions 68 is attached to one of the two bracket pieces of the front bracket 64. Meanwhile, the second attaching portion 70 is a pair of second attaching portions 70 provided at intermediate positions along the lengths of the respective longitudinal members 74. Each of the second attaching portions 70 is configured to be detachably attached to the rear attachment structure 72. In the illustrated embodiment, the rear attachment structure 72 includes a pair of support brackets 76. Each of the support brackets 76 is provided on the upper end of one of the first pillar 36 and the second pillar 38. Preferably, each of the support brackets 76 is configured to enable the respective longitudinal member 74 of the limb riser 58 to be attached and detached. For example, the support bracket 76 may be provided with bolt holes or with threaded bolts welded thereto to enable second attaching portion 70 of the longitudinal member 74 to be attached securely to the support bracket 76 in a detachable manner. A person skilled in the field of work vehicles will understand that other suitable methods of attaching the second attaching portions 70 to the support brackets 76 may be employed. For example, the rear attachment structure 72 may include a clamp configured to receive the longitudinal members 74 and secure the limb riser 58 in place with a clamping force. In some embodiments, the limb riser 58 may be welded to the support structure 62.

In some embodiments, the operator cab 16 is configured to be tiltable with respect to the frame 12 of the work vehicle 10. For example, as depicted in FIGS. 8B and 10B, a hinge structure 88 may be provided on one side of the operator cab 16 to permit the operator cab 16 to be tilted away from the frame 12 toward one side or the other in the widthwise direction of the work vehicle 10. Tilting the operator cab 16 provides access for maintenance of components disposed underneath or within the operator cab 16. When the work vehicle 10 is provided with a tiltable operator cab 16, it is preferable for the limb riser 58 to be arranged so as not to inhibit the tilting of the operator cab 16. In other words, it is preferable for the limb riser structure 56 to be configured to permit the operator cab 16 to be tilted while limb riser structure 56 remains in place.

In the illustrated embodiment, the limb riser structure 56 is configured to be supported with respect to the work vehicle 10 by the front attachment structure 60 and the support structure 62 without any portion of the limb riser structure 56 being connected to the operator cab 16 of the work vehicle 10. The limb riser 58 extends beyond the support structure 62 toward the operator cab 16. A rearward end of the limb riser 58 is disposed forward of the operator cab 16 when the limb riser structure 56 is installed on the work vehicle 10. As a result, a space or gap exists between the rearward end of the limb riser 58 and the operator cab 16. In the illustrated embodiment, the rearward end of the limb riser 58 is includes a transverse member 92 that joins the rearward ends of the two longitudinal members 74 and the gap is between the transverse member 92 and the operator cab 16. Consequently, the limb riser structure 56 is not attached to or supported by the operator cab 16, and the limb riser structure 56 does not inhibit or interfere with tilting of the operator cab 16. Those skilled in the field of work machines will recognize that the present disclosure is not limited to the exact positional relationship between the rearward end of the limb riser 58 and the operator cab 16 that is described herein and shown in the drawings. Any arrangement is acceptable so long as the operator cab 16 can be tilted while leaving the limb riser structure 56 in place. So long as the limb riser structure 56 is fully supported by the front attachment structure 60 and the support structure 62 and it is not necessary for the limb riser structure 56 to be attached to or supported by the operator cab 16, the limb riser structure 56 can be configured so not to interfere with the tilt movement of the operator cab 16.

Since the operator cab 16 can be tilted while the limb riser structure 56 remains in place without inhibiting the tilt movement of the operator cab 16, it is not necessary for an operator to perform the work required to detach the limb riser 58 from the operator cab 16 and to position the limb riser 58 out of the way so that it does not interfere with the operator cab 16. This arrangement not only improves convenience for the operator. It also improves safety because it is not necessary for the operator to climb onto a wheel or the vehicle body 14 of the work vehicle 10 to detach the limb riser 58 from the operator cab 16. Specifically, since work vehicles provided with limb risers are often used in wet and muddy conditions, climbing onto the wheel or the vehicle body 14 to detach the limb riser 58 from the operator cab 16 involves the risk of the operator slipping and falling from the work vehicle 10. Moreover, since the limb riser 58 is not supported by the operator cab 16, the transfer of vibrations and noise to the operator cab 16 due to limbs and other materials hitting the limb riser 58 can be reduced when the work vehicle 10 moves forested areas or other areas having materials that strike the limb riser 58.

Since the support structure 62 is configured as a structural weldment to support the limb riser 58, the support structure 62 is structurally sound enough to support the air pre-cleaner 48 and the air cleaner 52. In conventional work vehicles, the air cleaner is typically supported on the hydraulic tank and the air pre-cleaner is disposed above the hood. Conversely, in the present disclosure, the entire air intake system (including the screen, the air pre-cleaner 48, and the air filter or the air cleaner 52) can be supported by the support structure 62. More specifically, the air pre-cleaner 48 and the air cleaner 52 are mounted to the connecting member 44 spanning between the first pillar 26 and the second pillar 38. As result, it is not necessary to connect or support the air cleaner 52 with respect to the hydraulic tank and both the air-pre-cleaner 48 and air cleaner 52 can be disposed below the hood 30. This arrangement decouples the hydraulic tank from the engine compartment 26 of the work vehicle 10 and prevents stresses from the limb riser 58, the air intake weldment, (support structure 62), the hood 30, and the front hose (engine tube 54) from being transferred to the hydraulic tank.

Since the air pre-cleaner 48 of the present disclosure is disposed below the hood 30, the air pre-cleaner 48 can be protected from damage in comparison to the air pre-cleaners of conventional work vehicles, which are exposed due to being arranged above the hood. Furthermore, the visibility in the frontward direction of the work vehicle is improved by arranging the air pre-cleaner 48 below the hood 30. In conventional vehicles with the air pre-cleaner disposed above the hood, the air pre-cleaner blocks the view of the operator, which is generally restricted already due to the hood and engine compartment. Having the air pre-cleaner disposed below the hood removes the need for an intake stack coming out of the hood.

The arrangement of the ducts 40 and the air intake ports 42 in the present disclosure also provides advantages from the standpoint of where to pull cool, clean air from on a piece of machinery that mostly used the woods. The ducts 40 and air intake ports 42 are mounted to or incorporated into the first pillar 36, the second pillar 38, and the connecting member 44 of the support structure 62. Thus, the support structure 62 is a structural member that also serves as the air intake structure. In addition to reducing noise transferred to the operator cab 16 as the machine drives through low hanging limbs, this design pulls cool air through the first pillar 36 and the second pillar 38 (which are structural members) from the center of the hood 30 without restricting the forward-facing view of the operator. Also since the air intake ports 42 face inward toward each other, the screens or grates of the air intake ports 42 are better protected from branches and other materials than if the air intake ports faced outward. Mud, dust, and other materials are also less likely to be drawn into the ducts 40 through the air intake ports 42 because the air intakes ports 42 face inward toward the hood 30.

Many parts of the work vehicle are conventional components that are well known in the work vehicle field. Since these components are well known in the work vehicle field, these structures are not discussed or illustrated in detail herein, except as related to the disclosure set forth in the following claims.

As used herein, the following directional terms “forward,” “rearward,” “above,” “downward,” “vertical,” “horizontal,” “below,” “widthwise,” and “transverse” as well as any other similar directional terms refer to those directions of a work vehicle on a level surface. Accordingly, these terms, as utilized to describe the present disclosure should be interpreted relative to a work vehicle equipped with the present disclosure. The terms of degree such as “substantially”, “about” and “approximately” as used herein mean an amount of deviation of the modified term such that the end result is not significantly changed.

While only selected embodiments have been chosen to illustrate the present invention, the present disclosure is not limited to the illustrated embodiments. For example, although the illustrated embodiment discloses the air intake structure (duct 40 and air intake port 42) incorporated into a limb riser structure, the air intake structure could be incorporated into a roll bar or other protective structure provided on a work machine. Also, although the support structure 62 of the limb riser structure 56 of the illustrated embodiment includes two ducts 40 and two air intake ports 42, the support structure 62 could be configured to have only one air intake port 42 provided in one of the first pillar 36 or the second pillar 38. It will be apparent to those skilled in the work vehicle field from this disclosure that various changes and modifications can be made herein without departing from the scope of the invention as defined in the appended claims. Furthermore, the foregoing descriptions of the embodiments according to the present disclosure are provided for illustration only, and not for the purpose of limiting the invention as defined by the appended claims and their equivalents. Thus, the scope of the invention is not limited to the disclosed embodiments.

What is claimed is:

1. A limb riser structure for a work vehicle, the limb riser structure comprising:
an attachment structure configured to be attached to an end portion of a vehicle body of the work vehicle;
a support structure configured to be disposed in a position between a cab of the work vehicle and the end portion of the vehicle body; and
a limb riser having a first attaching portion attached to the attachment structure and a second attaching portion attached to the support structure, the limb riser extending toward the cab from the end portion.

2. The limb riser structure according to claim 1, wherein
the limb riser structure is configured to be supported with respect to the work vehicle by the attachment structure and the support structure without being connected to the cab of the work vehicle.

3. The limb riser structure according to claim 1, wherein
the support structure is configured to be disposed between the cab and a furthest point of the work vehicle.

4. The limb riser structure according to claim 1, wherein the limb riser extends beyond the support structure toward the cab.

5. The limb riser structure according to claim 4, wherein
a rearward end of the limb riser is disposed forward of the cab when the limb riser structure is installed on the work vehicle.

6. The limb riser structure according to claim 4, wherein
a space exists between the rearward end of the limb riser and the cab when the limb riser structure is installed on the work vehicle.

7. The limb riser structure according to claim 1, wherein
the support structure includes a duct and an air intake port communicating between the inside and the outside of the duct.

8. The limb riser structure according to claim 7, wherein
the support structure includes a tubular member that both forms the duct and supports the limb riser.

9. The limb riser structure according to claim 8, wherein
the tubular member is a pillar configured to be attached to a frame of the work vehicle in an upright orientation.

10. The limb riser structure according to claim 1, wherein
the support structure includes a pair of pillars configured to be attached to a frame of the work vehicle in an upright orientation, the pillars being spaced apart from each other in a widthwise direction of the work vehicle, each of the pillars forming a duct and having an air intake port communicating between an inside and an outside of the duct.

11. The limb riser structure according to claim 10, wherein
the air intake port of each of the pillars faces inward in the widthwise direction of the work vehicle.

12. An air intake structure for a work vehicle, the air intake structure comprising:
a first pillar and a second pillar configured to be attached to a frame of the work vehicle in an upright orientation, the first pillar and the second pillar being spaced apart from each other in a widthwise direction of the work vehicle, each of the first pillar and the second pillar forming a duct and having an air intake port communicating between an inside and an outside of the duct,
an air pre-cleaner connected to the duct of the first pillar and the duct of the second pillar.

13. The air intake structure according to claim 12, wherein
the air intake ports of the first pillar and the second pillar face inward in the widthwise direction of the work vehicle.

14. The air intake structure according to claim 12, further comprising:
a connecting member spanning between the first pillar and the second pillar, the connecting member having an internal space communicating with the duct of the first pillar and the duct of the second pillar,
the air pre-cleaner being connected to the duct of the first pillar and the duct of the second pillar via the connecting member.

15. The air intake structure according to claim 14, wherein
the air intake structure is configured such that the connecting member and the air pre-cleaner are disposed below a hood of the work vehicle when the air intake structure is installed on the work vehicle.

16. The air intake structure according to claim 14, further comprising:
an engine tube connected to an outlet side of the air pre-cleaner and configured to be connected to an air induction port of an engine.

17. The air intake structure according to claim 16, further comprising:
an air cleaner disposed between the air pre-cleaner and the engine tube.

18. The air intake structure according to claim 17, further comprising:
an air box disposed between the air pre-cleaner and the air cleaner such that air exiting the air pre-cleaner enters the air box before flowing into the air cleaner.

19. A work vehicle comprising:
a cab;
an engine;
a hood covering the engine;
an air pre-cleaner disposed under the hood between the engine and the cab; and
a limb riser structure including a limb riser and a duct connected to the air pre-cleaner, the duct communicating between an inlet side of the air pre-cleaner and ambient air.

20. The work vehicle according to claim 19, wherein
the cab is configured to be tiltable with respect to a frame of the work vehicle; and
the limb riser structure is configured to permit the cab to be tilted while limb riser structure remains in place.
